(19) United States
(12) Patent Application Publication
(10) Pub. No.: US 2025/0156843 A1
(43) Pub. Date: May 15, 2025

(54) SYSTEMS AND METHODS FOR MULTI-TAP INTERACTIONS BETWEEN A USER DEVICE AND CONTACTLESS CARD

(71) Applicant: Capital One Services, LLC, McLean, VA (US)

(72) Inventors: Joshua EDWARDS, Carrollton, TX (US); Tyler MAIMAN, Melville, NY (US); Kevin OSBORN, Newton Highlands, MA (US)

(21) Appl. No.: 18/389,330

(22) Filed: Nov. 14, 2023

(51) Int. Cl. G06Q 20/34; G06Q 20/32

(52) U.S. Cl. CPC G06Q 20/352; G06Q 20/325

(57) ABSTRACT

This application relates generally to systems and methods for enabling a user device to detect multiple taps from a contactless card. The user device reads the contactless card for a time stamp, replaces the time stamp with a new time stamp, and determines whether the card has been recently tapped.

### FIELD OF THE DISCLOSURE

The present disclosure relates to systems and methods for user authentication with a contactless card and a user device.

### BACKGROUND

Login credentials play a crucial role in ensuring secure access to various online services and platforms. However, conventional login methods, such as usernames and passwords, pose significant challenges, particularly for individuals with disabilities like poor eyesight and diminished motor function. For example, these traditional credentials often rely on visual elements, making it difficult for visually impaired individuals to accurately input their login information. This results in a frustrating user experience and potential security risks, as users may resort to insecure practices like sharing passwords or using easily guessable credentials.

To address this problem, there is a need for an innovative solution that caters to the unique needs of individuals with disabilities, particularly those with poor eyesight. The present invention aims to provide an alternative login system that enhances accessibility and security.

### SUMMARY OF THE DISCLOSURE

In some aspects, the techniques described herein relate to a system, including: a contactless card including a card memory; and a user device application including instructions for execution on a user device including a memory and a processor, wherein the user device application is configured to: after a first entry of the contactless card into a communication field, read the card memory, clear the card memory, transmit, over the communication field, a first time datum to the contactless card, wherein the card memory stores the first time datum, after a second entry of the contactless card into the communication field, read the first datum from the contactless card, compare the first time datum with a current counter value, clear the card memory of the contactless card, transmit a second time datum to the contactless card, wherein the card memory stores the second time datum, determine if the amount of time that has passed between the first time datum and the second time datum is within a predetermined time period, and perform, upon determining that the time that has passed between the first time datum and the second time datum is within the predetermined time period, an action.

In some aspects, the techniques described herein relate to a method, including: opening, by a user device application including instructions for execution on a user device, a communication field; after a first entry of a contactless card into the communication field, reading, by the user device application, a card memory associated with the contactless card; clearing, by the user device application, the card memory; transmitting, by the user device application over the communication field, a first time datum to the contactless card, wherein the card memory stores the first time datum; after a second entry of the contactless card into the communication field, reading, by the user device application, the first datum from the card memory; comparing, by the user device application, the first time datum with a current counter value; clearing, by the user device application, the card memory; transmitting, by the user device application, a second time datum to the contactless card, wherein the card memory stores the second time datum; determining, by the user device application, if the amount of time that has passed between the first time datum and the second time datum is within a predetermined time period; and performing, by the user device application upon determining that the time that has passed between the first time datum and the second time datum is within the predetermined time period, an action.

In some aspects, the techniques described herein relate to a non-transitory computer readable medium containing computer executable instructions that, when executed by a device including a processor, configure the computer hardware arrangement to perform procedures including: opening a communication field; after a first entry of a contactless card into the communication field, reading a card memory associated with the contactless card; clearing the card memory; transmitting, over the communication field, a first time datum to the contactless card, wherein the card memory stores the first time datum; after a second entry of the contactless card into the communication field, reading the first datum from the card memory; comparing the first time datum with a current counter value; clearing the card memory; transmitting a second time datum to the contactless card, wherein the card memory stores the second time datum; determining if the amount of time that has passed between the first time datum and the second time datum is within a predetermined time period; and performing, upon determining that the time that has passed between the first time datum and the second time datum is within the predetermined time period, an action.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an exemplary embodiment.

FIG. 2 is a diagram illustrating a contactless card according to an exemplary embodiment.

FIG. 3 is a diagram illustrating a contact pad of a contactless card according to an exemplary embodiment.

FIG. 4 is a diagram illustrating a contactless card with a visual element according to an exemplary embodiment.

FIG. 5 is a diagram illustrating a process according to an exemplary embodiment.

FIGS. 6A and 6B are diagrams illustrating a process according to an exemplary embodiment.

FIG. 7 is a flowchart illustrating a method according to an exemplary embodiment.

FIGS. 8A and 8B are diagrams illustrating a method according to an exemplary embodiment.

FIGS. 9A, 9B, and 9C are diagrams illustrating a method according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features and advantages of the embodiments may be combined in any suitable manner. One skilled in the art will recognize that the embodiments may be practiced without one or more of the features or advantages of an embodiment, and one skilled in the art will recognize the features or advantages of an embodiment can be interchangeably combined with the features and advantages of any other embodiments. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The system described in the claims comprises a contactless card with a non-volatile memory and a user device equipped with a memory and a processor. The process begins by opening a communication field and reading the non-volatile memory of the contactless card when it enters the field. The memory of the contactless card is then cleared, and a first time datum is transmitted to the card, which is stored in its memory.

Subsequently, a second communication field is opened, and the first datum is read when the contactless card enters this field. The first time datum is compared with a current counter value, and the memory of the contactless card is cleared again. A second time datum is transmitted to the card and stored in its memory. The processor then determines if the time elapsed between the first time datum and the second time datum falls within a predetermined time period. If the time is within the predetermined period, an action is performed. The system can provide additional visual feedback on the user device's display to indicate the status of communication with the contactless card. It can also offer haptic feedback to enhance the user experience. The processor may track the number of interactions between the card and the device within the predetermined time period, measure the duration of the card's presence in the communication fields, and allow users to adjust the predetermined time period as per their preferences. The method described in the claims involves similar steps, including opening communication fields, reading and clearing the contactless card's memory, transmitting time data, comparing time values, and performing actions based on the determined time period. The method may also involve additional procedures such as opening a third communication field, detecting card motions, adjusting the predetermined time period dynamically, and storing time data in the user device's memory. Overall, this invention enables secure and efficient interaction between a contactless card and a user device, utilizing time-based data comparisons to authenticate and perform actions within a predetermined time period.

Once the multi-tap gesture has been recognized by the user device application, a wide range of actions can be performed to cater to the diverse needs and requirements of users. The actions can vary from basic device operations to more complex interactions and services, aiming to enhance accessibility and convenience for individuals with different abilities and challenges. For users with poor eyesight, the user device application can initiate actions such as activating a voice assistant for hands-free operation, increasing the font size or enabling high-contrast display settings for improved readability, or launching an accessibility feature that provides spoken feedback or audio descriptions. In terms of motor skills, the user device application can offer actions that reduce the need for precise touch gestures. For example, a simplified gesture or voice command can unlock the phone or perform specific functions like launching frequently used apps, composing text messages, making phone calls to predefined contacts, or accessing important information such as emergency contacts or medical details. To assist with navigation, the user device application can integrate with map apps and offer actions like inputting a route home or to a frequently visited location, finding nearby points of interest, or providing step-by-step directions with voice guidance. In situations where immediate assistance is required, the user device application can trigger actions like calling a taxi service, contacting emergency services, or activating an alert service that notifies designated contacts or emergency responders. The user device application can be customized and personalized to meet the specific needs of individual users. This allows for a tailored experience, where actions are selected based on the user's preferences, capabilities, and daily requirements. By offering a wide array of actions, the user device application empowers users with enhanced accessibility, independence, and seamless interaction with their devices.

Systems and methods of the present disclosure provide numerous advantages. For example, the embodiments provide enhanced security over conventional systems and methods. The use of contactless cards with non-volatile memory and the time-based data comparison mechanism provide an added layer of security. By validating the time elapsed between data transmissions, the system can detect potential unauthorized access attempts or cloning of cards.

Furthermore, the multi-tap method offer convenient authentication. The contactless nature of the cards eliminates the need for physical contact or manual input of login credentials, making the authentication process more convenient and user-friendly. Additionally, the system addresses the needs of users with poor eyesight by providing visual and haptic feedback on the user device. This feature enhances the user experience and facilitates accessibility for individuals with visual impairments. Conventional login credentials often rely heavily on visual elements, such as text-based passwords or on-screen prompts. Such reliance on visual input can pose challenges for individuals with poor eyesight. However, the invention eliminates the need for manual input or reading of visual information. Instead, it utilizes contactless cards and non-volatile memory, which can be accessed and interacted with without relying on visual cues. The system's flexibility allows users to adjust the predetermined time period and potentially customize other accessibility settings. This customization ensures that individuals with different needs and abilities can adapt the authentication process to suit their preferences. By empowering users to modify the system according to their specific accessibility requirements, the invention promotes inclusivity and accommodates a wider range of users. The contactless nature of the system eliminates the need for manual input of login credentials, such as typing passwords or physically interacting with small buttons or keys. This reduction in physical effort can be particularly beneficial for individuals with limited motor control or dexterity due to muscular disorders. They can simply bring the contactless card within the communication field, removing the need for precise movements or fine motor skills.

In some embodiments, the contactless card is equipped with a display element. This feature goes beyond conventional authentication devices, which typically lack any display capabilities. The display element allows for additional visual feedback and interaction, providing users with clearer status updates, prompts, or notifications. It enhances the overall user experience and facilitates better communication between the user and the system.

The application also offers improved flexibility and customization by the user. Users have the ability to adjust the predetermined time period according to their preferences, allowing for customization and flexibility in the authentication process.

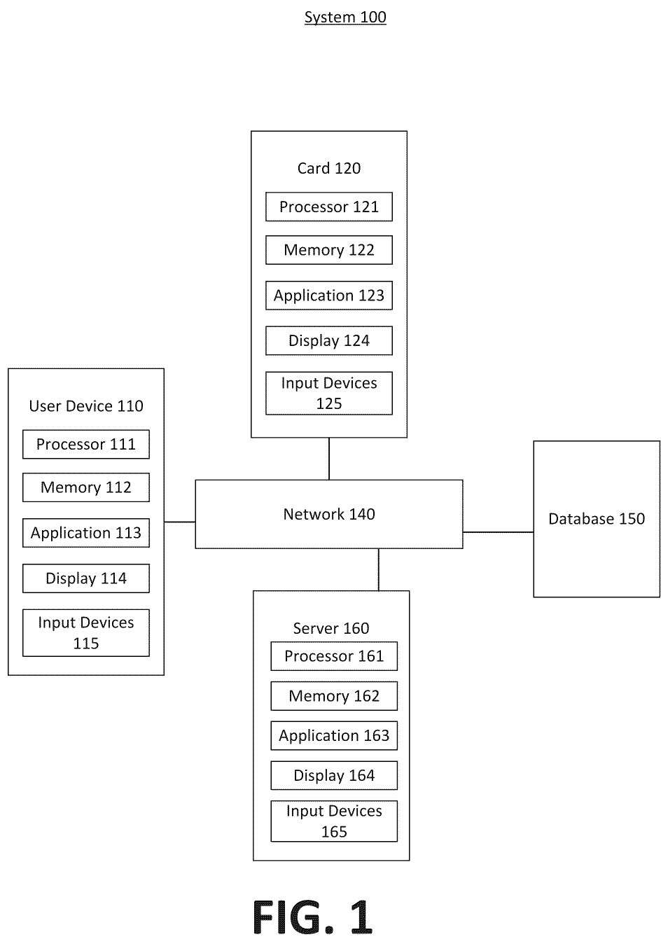

FIG. 1 illustrates a system 100 according to an exemplary embodiment. The system 100 may comprise a user device 110, a card 120, a payment information processor 130, a network 140, a database 150, and a server 160. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

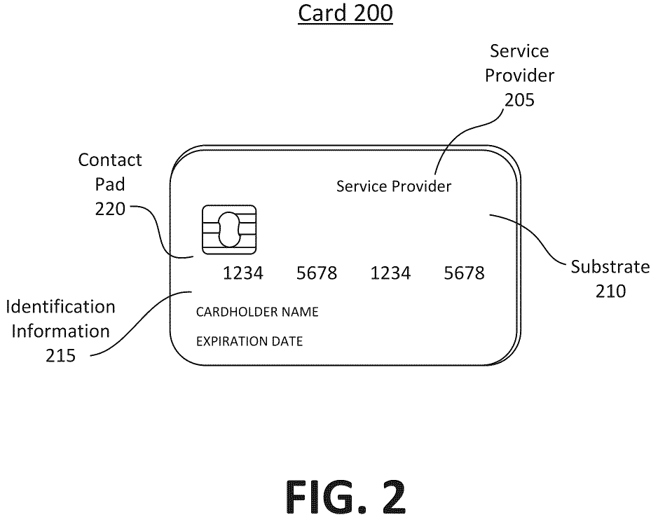

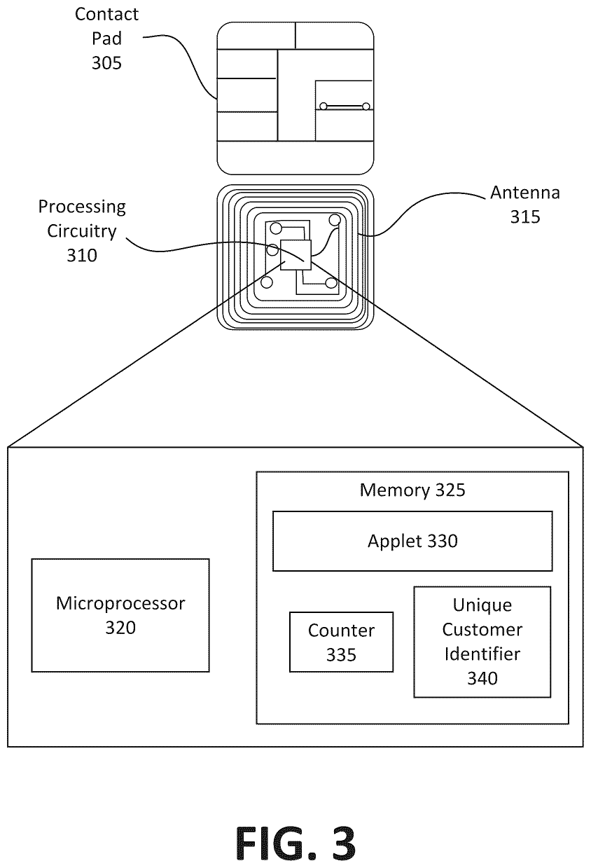

System 100 may include one or more contactless cards 120 which are further explained below with reference to FIG. 2 and FIG. 3. In some embodiments, contactless card 120 may be in wireless communication, utilizing NFC in an example, with user device 110.

System 100 may include one or more networks 140. In some examples, the network 140 may be one or more of a wireless network, a wired network or any combination of wireless network and wired network, and may be configured to connect the user device 110, the contactless card 120, the payment information processor 130, the database 150 and the server 160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 160 or may be hosted externally of the server 160, such as by a server, by a cloud-based platform, or in any storage device that is in data communication with the server 160.

The server 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 160 may include a processor 161, a memory 162, and an application 163. The processor 161 may be a processor, a microprocessor, or other processor, and the server 160 may include one or more of these processors. The server 160 can be onsite, offsite, standalone, networked, online, or offline.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the server 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the server 160. In some examples, the server 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the payment information processor 130 that is available and supported by the payment information processor 130, such as a touch-screen, keyboard, mouse, cursor-control device, touch-screen, microphone, digital camera, video recorder or camcorder. These devices may be used to enter information and interact with the software and other devices described herein.

In some examples, exemplary procedures in accordance with the present disclosure described herein can be performed by a processing arrangement and/or a computing arrangement (e.g., a computer hardware arrangement). Such processing arrangement and/or computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the user device 110, the card 120, the payment information processor 130, the network 140, the database 150, and the server 160 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 illustrates a contactless card 200 according to an exemplary embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, smart watch, some other wearable device, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the card (not shown in FIG. 2).

FIG. 3 illustrates a contact pad 305 of a contactless card according to an exemplary embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 325 may be non-volatile. Non-volatile memory is a type of computer memory that retains its stored data even when the power is turned off or lost. This is in contrast to volatile memory, which requires a continuous power supply to maintain data. In the context of the described embodiments, the non-volatile memory in the card stores essential information such as the time data. The usage of non-volatile memory is critical for maintaining the integrity of the stored information and ensuring that the card can reliably store and retrieve data even during power cycles or temporary disconnections. It allows the card to hold important data that is essential for the functioning of the system, such as the time data used in the interactions and comparisons described in the invention. Furthermore, the non-volatile memory, in the context of this invention, is designed to be both readable and writable by the software application running on the user device. This means that the application can read data from the card's memory and also write new data to it, such as the time data.

The application's ability to read from the memory is crucial for retrieving stored information like the time data and interaction history that's necessary for making comparisons and decisions within the communication field.

Additionally, the application's capability to write to the card's memory is essential for operations like clearing the memory after an interaction, storing new time data, and potentially updating other relevant information.

The memory 325 may be configured to store one or more applets 330, one or more counters 335, and a customer identifier 340. The one or more applets 330 may comprise one or more software applications configured to execute on one or more contactless cards, such as Java Card applet. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

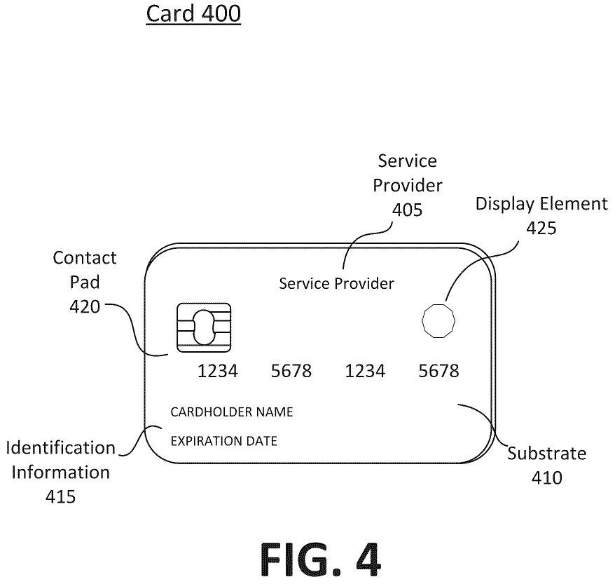

FIG. 4 illustrates a card 400 with a visual element. The contactless card 400 may comprise a payment card, such as a credit card, debit card, or gift card, issued by a service provider 405 displayed on the front or back of the card 400. In some examples, the payment card may comprise a dual interface contactless payment card. In some examples, the contactless card 400 is not related to a payment card, and may comprise, without limitation, an identification card, a membership card, a loyalty card, a transportation card, and a point of access card.

The contactless card 400 may comprise a substrate 410, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 400 may have physical characteristics compliant with the ID-1 format of the ISO/IEC 7810 standard, and the contactless card may otherwise be compliant with the ISO/IEC 14443 standard. However, it is understood that the contactless card 400 according to the present disclosure may have different characteristics, and the present disclosure does not require a contactless card to be implemented in a payment card.

The contactless card 400 may also include identification information 415 displayed on the front and/or back of the card, and a contact pad 420. The contact pad 420 may be configured to establish contact with another communication device, such as a user device, smart phone, laptop, desktop, smart watch, some other wearable device, or tablet computer. The contactless card 400 may also include processing circuitry, antenna and other components not shown in FIG. 4. These components may be located behind the contact pad 420 or elsewhere on the substrate 410. The contactless card 400 may also include a magnetic strip or tape, which may be located on the back of the card (not shown in FIG. 4).

The contactless card 400 may also include a visual element 425. The visual element 425 can be connected to the contact pad 420 by a service bus. The visual element 425 can be any light-emitting element including without limitation one or more light emitting diodes (LEDs). In other embodiments, the visual element can include at least one of an organic light-emitting diodes (OLED), a polymer light-emitting diode, an active-matrix organic light-emitting diode (AMOLED), or quantum dot light emitting diode (QLED). In some embodiments, the visual element can include reflective display elements such as e-ink displays and passive LCD. E-ink has the additional advantage that it does not require powering to be visible. The visual element 425 can be activated by one or more predetermined actions, including the receiving of one or more payment information from the user device application. Thus, the visual element 425 can indicate whether the contactless card 400 currently holds the payment information or is otherwise ready to transmit the payment information to the payment information processor or some other server. The user can, through the user device application, deactivate the visual element 425 by tapping the contactless card 400 to a user device via a communication field. In other embodiments, the visual element 425 can turn off once the card has transmitted the payment information and the distribution request to the payment information processor.

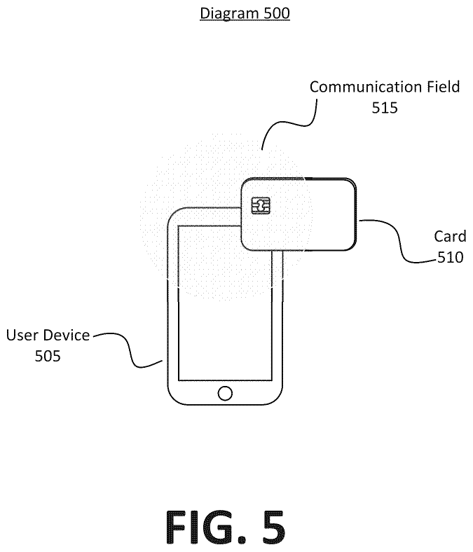

FIG. 5 is a diagram illustrating near field communication (NFC) according to an exemplary embodiment.

Generally, NFC is the transmission of data through electromagnetic radio fields which enable two or more devices to communicate with each other without touching. NFC operates at 13.56 MHz on ISO/IEC 18000-3 air interface and at rates ranging from 106 kbit/s to 424 kbit/s. When two NFC-enabled devices are placed within a very small distances (e.g. a few centimeters), they can perform a transaction of information. NFC is beneficial to consumer transactions because it allows for near instantaneous reading of information. The receiving device reads the transmitted data the instant that it is sent. Therefore, human error is greatly reduced. Additionally, NFC reduces the time need to read a card. Rather than swipe a card through a reader, a consumer can simply touch the card or user device to an NFC enabled reader. Additionally, NFC reduces the risk of interference from fraudulent parties. Because NFC devices may communicate only over a very short distance, it is extremely difficult to intercept the information being sent between the devices.

Some examples of NFC communication include NFC card emulation where smartphones act like smart cards allowing users to perform transactions such as payment. As another example, NFC reader/writer communication allows devices to read information stored on NFC tags embedded into labels or smart posters. As another example, NFC peer-to-peer communication allows two NFC-enabled devices to communicate with each other to exchange information.

NFC standards cover communications protocols and data exchange formats, and are based on existing RFID standards including ISO/IEC 14443 and FeliCa. The standards include ISO/IEC 18092 and those defined by the NFC Forum.

In FIG. 5, a user device 505 and a contactless card 510 are interacting within an NFC field 515. The user device is further explained with reference to FIG. 1. The contactless card is further explained with reference to FIGS. 2 and 3. Both the user device and contactless card may be enabled with NFC technology. The user and the card are in close contact with each other so that they can exchange information within the communication field.\

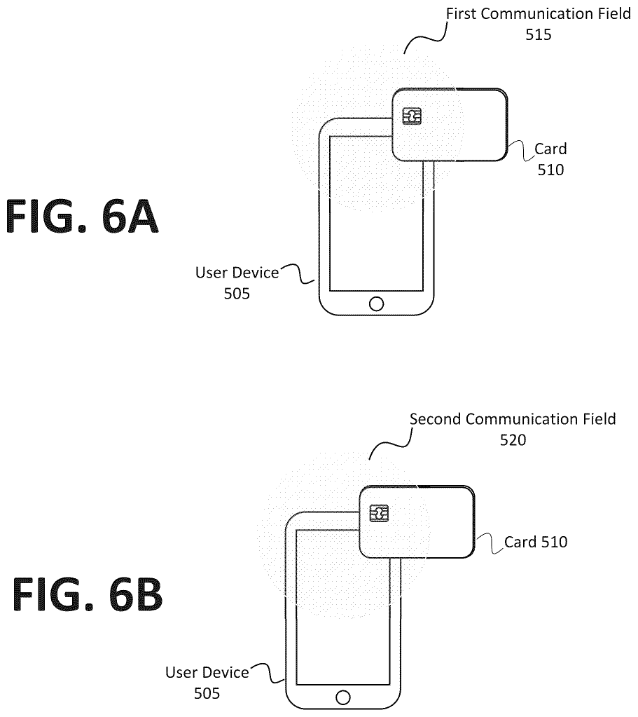

FIGS. 6A and 6B illustrates a process according to an example embodiment. The process can include a user device 505, contactless card 510, a first communication field 515, and a second communication field 520. It is understood that a user device application can be involved with each of the actions explained in FIGS. 6A and 6B. For example, the user device application can be processing each of the actions, storing the time datum, determining whether the tap happened quickly enough, and every other action described herein with respect to the user device.

In FIG. 6A, the user device 505 opens a first communication field 515, and the contactless card 510 enters the first communication field 515. This can be described as a “first tap” or first interaction between the user device 505 and the contactless card 510. When the card 510 enters the first communication field 515, the processor associated with the user device 505 reads the non-volatile memory of the contactless card 510. If the processor reads a time stamp or some time datum, it can store the time stamp or time datum in the memory of the user device 505. In some embodiments, the card can transmit unique identifiers or codes that help the user device identify the specific card being used. This information allows the user device to associate the card with the corresponding user account or authentication profile. The contactless card can transmit relevant card data, such as account numbers, cardholder names, expiration dates, or other details associated with the card. This data enables the user device to retrieve the necessary information for authentication or transaction purposes. The card may transmit security keys or authentication credentials that are required for establishing a secure connection or verifying the authenticity of the card. These keys or credentials are used by the user device to validate the card's identity and ensure secure communication. If the interaction involves a transaction, the contactless card can transmit specific transaction details, such as the transaction amount, merchant information, or any additional data required for completing the transaction. This information allows the user device to process the transaction accurately. After reading the data from the contactless card's memory, the user device 505 clears the non-volatile memory to ensure that the card is ready for the next interaction.

In FIG. 6B, the user device 505 opens a second communication field 520, and the contactless card 510 enters the second communication field 520. Presumably, the contactless card 510 has exited the first communication field 515, and the user device 505 subsequently ended the first communication field 515. The user device 505 again reads the non-volatile memory of the contactless card 510, thereby reading the first time datum. Upon reading the time datums from the card memory, the user device application has the capability to store these time datums for future reference and comparison. The user device application can utilize a dedicated memory associated with the user device or utilize other data storage units or databases to store the time datums. By storing the time datums, the user device application establishes a reference point for subsequent interactions with the contactless card. Storing the time datums enables the user device application to track and measure the temporal aspects of the interactions with the contactless card. It facilitates the calculation of time intervals, durations, or delays between different tap events. This information can be utilized for various purposes, such as authentication, transaction validation, or implementing time-based actions or functionalities.

The user device 505 compares the first time datum with a current counter value, which may be a value generated by a system clock or a timer. This comparison helps determine the elapsed time between the first communication field 515 and the second communication field 520, or the first tap and the second tap. When a new time datum is read from the contactless card during a subsequent interaction, the user device application can retrieve the previously stored time datum from the memory or storage unit. This allows for a direct comparison between the stored time datum and the newly read time datum. The comparison helps determine the elapsed time or time difference between the two interactions, providing valuable information for evaluating the timing or sequence of the taps or gestures performed.

The user device 505 clears the non-volatile memory of the contactless card 510 to prepare for subsequent interactions. The user device 505 sends a second time datum, representing the current time or a time-related value, to the contactless card 510. This datum is stored in the non-volatile memory of the card 510. The user device 505 compares the time difference between the first time datum and the second time datum with a predetermined time period. This determination helps evaluate whether the elapsed time falls within a desired range or some predetermined time. If the time difference falls within the predetermined time period, the user device initiates a specific action, which could be granting access, performing a transaction, or executing any other predefined operation associated with the authentication process.

Furthermore, in certain embodiments of the described invention, the user device is equipped with the capability to measure the duration of each tap performed by the contactless card. This feature allows for differentiating between taps of varying lengths, such as a long first tap followed by a short second tap, and enables the system to interpret these variations for specific actions or commands. To measure the duration of each tap, the user device employs various techniques based on the underlying hardware and sensing mechanisms. One approach could involve monitoring the presence of the contactless card within the communication field. The user device can track the entry and exit times of the card, calculating the time difference between these events to determine the duration of the tap. Another method may involve measuring the duration of the communication field itself. The user device can record the start and end times of each communication field, capturing the duration during which the contactless card remains within that field. By subtracting the start time of the second communication field from the end time of the first, the system can ascertain the duration of the first tap. Additionally, the detection of the card's antenna or other relevant signals can be utilized to measure the duration of each tap. The user device can analyze the signal strength or other characteristics over time to estimate the duration of the tap gesture. By accurately measuring the duration of each tap, the system can discern between different tap patterns and adapt its response accordingly. For instance, a long first tap followed by a short second tap might trigger a specific action or initiate a different sequence of operations compared to a uniform duration of taps. This capability adds an extra layer of interaction and control for users, enabling them to perform nuanced gestures and convey specific intentions through variations in tap duration. It enhances the versatility and customization of the system, empowering users to navigate through different functionalities or access specific features based on their individual preferences and requirements. In summary, the system can distinguish between different tap patterns and deliver tailored responses, offering users enhanced control and interaction possibilities.

Although the figures primarily depict a system with a first communication field and a second communication field, it is important to note that the concept of multiple interactions can be accommodated within a single communication field. In such cases, the user device can maintain an active communication field that allows for successive interactions with one or more contactless cards without the need to close and reopen the field for each interaction. For example, the user device can establish a continuous communication field that remains open while the user taps different cards to the user device. Each tap of a card within the ongoing communication field triggers the reading of the card's non-volatile memory, comparison of time data, and execution of the necessary actions based on predetermined criteria. The user device can handle multiple interactions seamlessly within the same communication field, eliminating the need to open and close separate fields for each card. Similarly, in a transactional context, a user may want to make multiple purchases using different contactless cards. The user device can maintain a persistent communication field while the user taps different cards for payment. The device reads the relevant data from each card, validates the transactions, and completes the payment process accordingly. This allows for a smooth and efficient experience without the interruption of opening and closing separate communication fields for each card. In these examples, a single communication field serves as the platform for multiple interactions with different contactless cards. This approach streamlines the process, reduces transaction time, and enhances user convenience. By understanding that multiple interactions can occur within a single communication field, the system can be designed to accommodate diverse use cases and optimize the user experience accordingly.

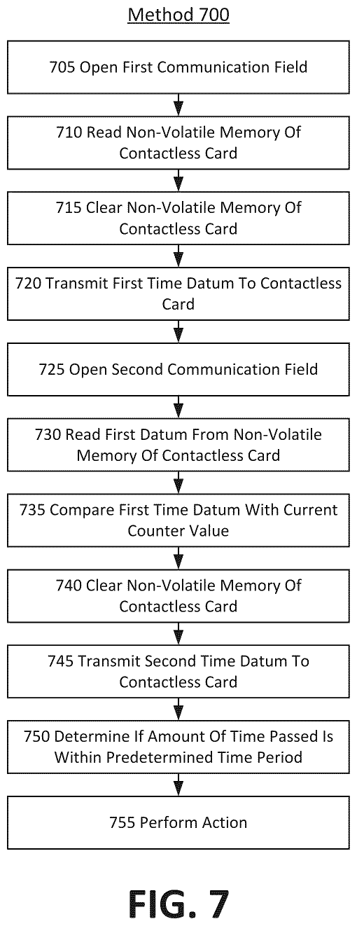

FIG. 7 is method performed by the processor associated with a user device and a contactless card discussed with further reference to FIGS. 1, 2, and 3. It is understood that a user device application can be involved with each of the actions explained in FIG. 7. For example, the user device application can be processing each of the actions, storing the time datum, determining whether the tap happened quickly enough, and every other action described herein with respect to the user device.

In action 705, the user device initiates the first communication field, creating a proximity zone for interaction with the contactless card. It establishes a communication channel between the user device and the card.

In action 710, the user device reads the data stored in the non-volatile memory of the contactless card. This data may include previously stored information related to the card or previous interactions. For example, the user device retrieves the stored authentication token from the contactless card's memory, which was previously saved during the contactless card's last interaction with the user device via a communication field. Upon reading the time datums from the card memory, the user device application has the capability to store these time datums for future reference and comparison. The user device application can utilize a dedicated memory associated with the user device or utilize other data storage units or databases to store the time datums. By storing the time datums, the user device application establishes a reference point for subsequent interactions with the contactless card. Storing the time datums enables the user device application to track and measure the temporal aspects of the interactions with the contactless card. It facilitates the calculation of time intervals, durations, or delays between different tap events. This information can be utilized for various purposes, such as authentication, transaction validation, or implementing time-based actions or functionalities. When a new time datum is read from the contactless card during a subsequent interaction, the user device application can retrieve the previously stored time datum from the memory or storage unit. This allows for a direct comparison between the stored time datum and the newly read time datum. The comparison helps determine the elapsed time or time difference between the two interactions, providing valuable information for evaluating the timing or sequence of the taps or gestures performed.

In action 715, after reading the data, the user device clears the non-volatile memory of the contactless card. This ensures that any residual or outdated information is removed before proceeding with the next steps. The user device erases the authentication token from the contactless card's memory to maintain data security and prevent unauthorized access. In action 720, The user device sends a first time datum (e.g. a timestamp or counter value) to the contactless card. This time datum is stored in the non-volatile memory of the card for later comparison and time calculation purposes. The user device transmits the current system time to the contactless card, which is then stored in the card's memory as the first time datum. In action 725, once the first time datum is transmitted, the user device opens a second communication field, indicating the initiation of the next phase of the interaction. This presumably happens after the contactless card has been removed from the first communication field, then brought back near the user device for a “second tap” or second interaction.

In action 730, the user device reads the first time datum from the non-volatile memory of the contactless card, which was stored during the previous step. The user device retrieves the first time datum (previously stored system time) from the contactless card's memory for comparison and time calculation. In action 735, the user device compares the first time datum obtained from the card's memory with the current counter value or timestamp. This comparison helps determine the elapsed time between the first and second communication fields. In action 740, the user device clears the non-volatile memory of the contactless card to ensure data integrity and remove any residual information. In action 745, the user device transmits a second time datum (current timestamp or counter value) to the contactless card, which will be stored in the card's memory for future comparisons. For example, the user device sends the current system time as the second time datum to the contactless card for storage.

In action 750, the user device calculates the time difference between the first and second time data and determines if it falls within the predetermined time period. If the elapsed time is within the specified range, the condition is met. For example, if the user device compares the time difference between the first and second time data with a predetermined time period of ten seconds. In action 755, if the amount of time passed between the first and second time data is within the predetermined time period, the user device performs a specific action or executes a particular operation. For example, if the elapsed time is within the specified range of 10 seconds, the user device unlocks a secure feature or initiates a transaction authorized by the contactless card.

While the FIG. 7 illustrates the concept using two communication fields, it is understood that in other embodiments it can be extended to accommodate a greater number of communication fields and taps. The use of additional communication fields allows for increased flexibility and a wider range of interactions between the user device and the contactless card.

For example, the process can include three, four, or even more communication fields, each corresponding to a specific tap or gesture. This means that users can perform a sequence of taps or gestures to trigger different actions or access various functionalities associated with the contactless card.

For example, the system supports three communication fields. In this case, the user device would open a first communication field upon detecting the card's presence. The card would then enter the first field. The user device can read data from the card's non-volatile memory, transmit a first time datum, and perform any necessary operations associated with this tap. Next, the user device would open a second communication field, and upon the card entering this field. The device would read the first datum from the card's memory, compare it with the current counter value, clear the card's memory, transmit a second time datum, and perform relevant actions accordingly. Following the second tap, the user device would open a third communication field, and the card's entry into this field would signify the third tap. The device would repeat the process by reading the previous datum, comparing it with the counter value, clearing the memory, transmitting a third time datum, and executing the corresponding action.

By extending the number of communication fields and taps, the system offers a more versatile and interactive experience. This allows for the implementation of complex gestures or sequences, enabling users to access different features, navigate menus, initiate transactions, or perform various other actions based on their specific needs and preferences. In summary, while the figure depicts the concept with two communication fields, the invention is not limited to this configuration. Other embodiments can utilize three, four, or any number of communication fields, each corresponding to a specific tap or gesture, to provide users with a more extensive range of interactions and functionalities.

Furthermore, in certain embodiments of the described invention, the user device is equipped with the capability to measure the duration of each tap performed by the contactless card. This feature allows for differentiating between taps of varying lengths, such as a long first tap followed by a short second tap, and enables the system to interpret these variations for specific actions or commands. To measure the duration of each tap, the user device employs various techniques based on the underlying hardware and sensing mechanisms. One approach could involve monitoring the presence of the contactless card within the communication field. The user device can track the entry and exit times of the card, calculating the time difference between these events to determine the duration of the tap. Another method may involve measuring the duration of the communication field itself. The user device can record the start and end times of each communication field, capturing the duration during which the contactless card remains within that field. By subtracting the start time of the second communication field from the end time of the first, the system can ascertain the duration of the first tap. Additionally, the detection of the card's antenna or other relevant signals can be utilized to measure the duration of each tap. The user device can analyze the signal strength or other characteristics over time to estimate the duration of the tap gesture. By accurately measuring the duration of each tap, the system can discern between different tap patterns and adapt its response accordingly. For instance, a long first tap followed by a short second tap might trigger a specific action or initiate a different sequence of operations compared to a uniform duration of taps. This capability adds an extra layer of interaction and control for users, enabling them to perform nuanced gestures and convey specific intentions through variations in tap duration. It enhances the versatility and customization of the system, empowering users to navigate through different functionalities or access specific features based on their individual preferences and requirements. In summary, the system can distinguish between different tap patterns and deliver tailored responses, offering users enhanced control and interaction possibilities.

Although the figures primarily depict a system with a first communication field and a second communication field, it is important to note that the concept of multiple interactions can be accommodated within a single communication field. In such cases, the user device can maintain an active communication field that allows for successive interactions with one or more contactless cards without the need to close and reopen the field for each interaction.

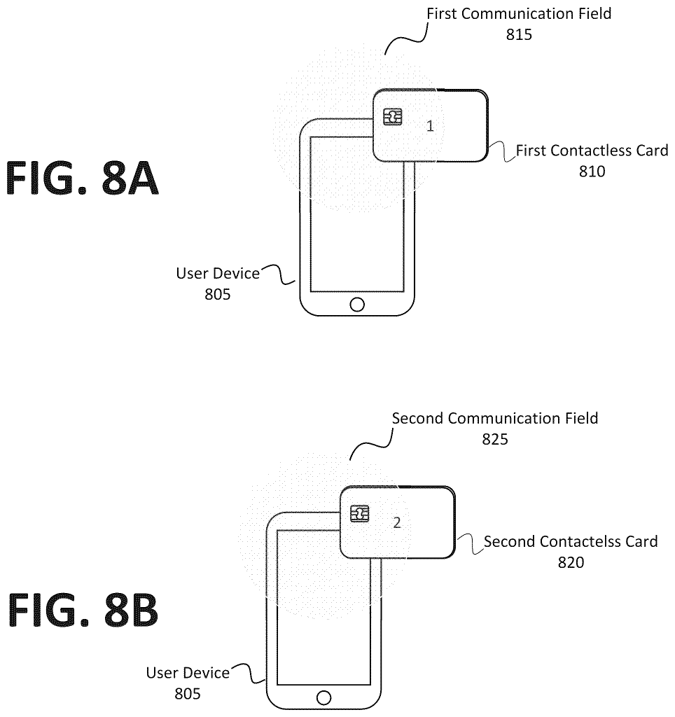

FIGS. 8A and 8B illustrate a method where two separate contactless cards communicated with the user device over two separate communication fields. The method can include a user device 805, a first contactless card 810, a second contactless card 820, a first communication field 815, and a second communication field 825. It is understood that a user device application can be involved with each of the actions explained in FIGS. 8A and 8B. For example, the user device application can be processing each of the actions, storing the time datum, determining whether the tap happened quickly enough, and every other action described herein with respect to the user device.

In FIG. 8A, the user device 805 opens a first communication field 815, and the contactless card 810 enters the first communication field 815. This can be described as a “first tap” or first interaction between the user device 805 and the first contactless card 810. When the first contactless card 810 enters the first communication field 815, the processor associated with the user device 805 reads the non-volatile memory of the first contactless card 810. If the processor reads a time stamp or some time datum, it can store the time stamp or time datum in the memory of the user device 805. In some embodiments, the card can transmit unique identifiers or codes that help the user device identify the specific card being used as well as the specific user associated with the card. This information allows the user device to associate the card with the corresponding user account or authentication profile. For example, the first contactless card 810 can be associated with a first user, and the second contactless card 820 can be associated with a second user. Furthermore, the contactless cards can transmit relevant card data, such as account numbers, cardholder names, expiration dates, or other details associated with the card. This data enables the user device 805 to retrieve the necessary information for authentication or transaction purposes. The contactless cards may transmit security keys or authentication credentials that are required for establishing a secure connection or verifying the authenticity of the card. These keys or credentials are used by the user device 805 to validate the card's identity and ensure secure communication. If the interaction involves a transaction, the contactless cards can transmit specific transaction details, such as the transaction amount, merchant information, or any additional data required for completing the transaction. This information allows the user device to process the transaction accurately. After reading the data from the memory associated with the first contactless card 810, the user device 805 clears the non-volatile memory to ensure that the first contactless card 810 is ready for the next interaction.

In FIG. 8B, the second tap is performed with a second contactless card 820. The user device 805 opens a second communication field 825, and the second contactless card 820 enters the second communication field 825. The first contactless card 810 has already exited the first communication field 815, and the user device 805 has ended the first communication field 815 accordingly. As in FIG. 8A, the processor associated with the user device 805 reads the non-volatile memory of the second contactless card 820. If the processor reads a time stamp or some time datum, it can store the time stamp or time datum in the memory of the user device 805. In some embodiments, the card can transmit unique identifiers or codes that help the user device 805 identify the specific card being used as well as the specific user associated with the card. This information allows the user device to associate the card with the corresponding user account or authentication profile. The user device 805 reads the non-volatile memory of the second contactless card 820 upon its entry into the second communication field 825, retrieving the first time datum stored by the second contactless card 820. The user device 805 compares this first time datum with the current counter value, which represents the elapsed time between the first communication field 815 and the second communication field 825, or the first tap and the second tap. Because two different contactless cards are being used, the comparison of the first time datum with the current counter value allows the user device 805 to evaluate the time difference between the first card's tap and the second card's tap, i.e. the entry of the first contactless card 810 into the first communication field 815 and the entry of the second contactless card 820 into the second communication field 825. The non-volatile memory of the second contactless card 820 is cleared, and the user device 505 sends a second time datum, representing the current time or a time-related value, to the second contactless card 820, which is then stored in the non-volatile memory associated with the second contactless card 820. Finally, the user device 805 compares the time difference between the first time datum and the second time datum with a predetermined time period. If the time difference falls within the predetermined time period, the user device 805 proceeds to initiate a specific action associated with the authentication process, such as granting access or performing a transaction.

Upon reading the time datums from the card memory, the user device application has the capability to store these time datums for future reference and comparison. The user device application can utilize a dedicated memory associated with the user device or utilize other data storage units or databases to store the time datums. By storing the time datums, the user device application establishes a reference point for subsequent interactions with the contactless card. Storing the time datums enables the user device application to track and measure the temporal aspects of the interactions with the contactless card. It facilitates the calculation of time intervals, durations, or delays between different tap events. This information can be utilized for various purposes, such as authentication, transaction validation, or implementing time-based actions or functionalities. When a new time datum is read from the contactless card during a subsequent interaction, the user device application can retrieve the previously stored time datum from the memory or storage unit. This allows for a direct comparison between the stored time datum and the newly read time datum. The comparison helps determine the elapsed time or time difference between the two interactions, providing valuable information for evaluating the timing or sequence of the taps or gestures performed.

Although FIGS. 8A and 8B illustrate two contactless cards, it is understood that other embodiments can include more than two cards. The described system and methodology can easily accommodate the use of multiple contactless cards for authentication or transaction purposes. With multiple cards, the authentication process becomes more robust. Each card can possess unique identification information, authentication credentials, or security keys. By requiring the presence and verification of multiple cards, the system adds an extra layer of security, making it more difficult for unauthorized individuals to gain access or engage in fraudulent activities. Furthermore, multiple cards provide greater flexibility in terms of user authentication options. Users can utilize different cards for different purposes or access levels. For example, they may have a separate card for personal identification, another for financial transactions, and yet another for accessing secure areas. This versatility allows users to tailor their authentication approach based on specific requirements and preferences. Additionally, the system's ability to accommodate multiple cards allows for scalability. As the number of users or the complexity of authentication requirements increases, the system can easily scale by incorporating additional contactless cards. This scalability is particularly advantageous in settings such as corporate environments, educational institutions, or large-scale access control systems where numerous individuals need secure and efficient authentication.

Although the figures primarily depict a system with a first communication field and a second communication field, it is important to note that the concept of multiple interactions can be accommodated within a single communication field. In such cases, the user device can maintain an active communication field that allows for successive interactions with one or more contactless cards without the need to close and reopen the field for each interaction.

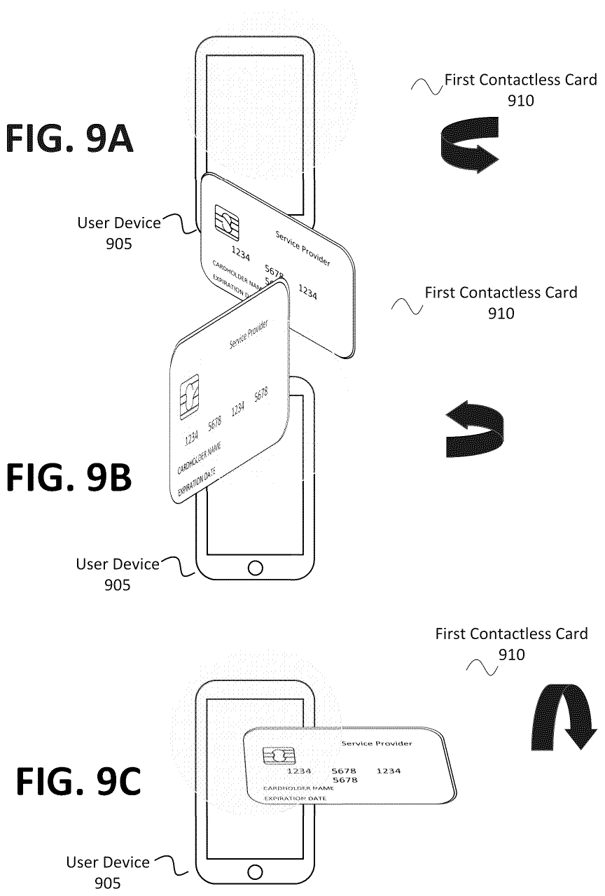

FIGS. 9A-9C is a diagram illustrating a method by which a user device recognizes the gesture of a contactless card as the card enters a communication field. FIG. 9A-9C illustrate how the contactless card 910 is being rotated in relation to the user device 905. For example, FIG. 9A illustrates a card rotating around the y-axis in one direction, and FIG. 9B illustrates a contactless card 910 rotating around the y-axis in the other direction. FIG. 9C illustrates a contactless card 910 rotating around the x-axis in one direction, although it is understood that the contactless card 910 can rotate in the either direction. It is understood that a user device application can be involved with each of the actions explained in FIGS. 6A and 6B. For example, the user device application can be processing each of the actions, storing the time datum, determining whether the tap happened quickly enough, and every other action described herein with respect to the user device.

The user device 905 can leverage its camera, in conjunction with a user device application, to detect and interpret gestures made with the contactless card 910. This capability expands the interaction possibilities beyond simple taps and introduces a new level of user engagement. By analyzing the card's orientation, motion, and gestures, the user device 905 can offer enhanced functionalities and intuitive control over various processes. As a nonlimiting example, the camera in the user device 905 captures the visual data of the contactless card 910 during its interaction. The user device application processes the camera feed, employing computer vision algorithms to detect and track the position, orientation, and movement of the contactless card 910. By analyzing the captured frames, the application can determine the relative distance and speed of the contactless card 910, providing valuable information about the interaction dynamics. Additionally, the camera's ability to detect the orientation and gestures of the contactless card 910 opens up possibilities for user-defined commands and customized interactions. For instance, a user may set up a gesture that, when performed over the contactless card 910, activates a specific function on the user device 905, such as launching a favorite application or controlling media playback. By associating gestures with predefined actions, the user device application can provide a personalized and intuitive user interface. Furthermore, the combination of the camera and antenna communication can enable advanced functionalities. The camera can provide visual cues and feedback during the interaction, such as displaying animations or highlighting areas of interest on the card. Simultaneously, the antenna communication facilitates the exchange of data between the user device 905 and the contactless card 910, allowing for real-time synchronization and dynamic adjustment of the application's behavior based on the detected gestures.

In a nonlimiting example involving multiple contactless cards, the camera-based gesture detection system can still differentiate between the gestures made by each card. The user device application, with its ability to process visual data from the camera feed, can analyze and interpret the gestures performed by each individual card. For example, consider a user device 905 equipped with a gesture-enabled application that supports two different contactless cards: Card A and Card B. Each card has its unique set of gestures associated with specific actions. The user holds both cards in their hands and performs different gestures over each card. As the user taps, swipes, or waves Card A, the camera captures the visual data and the user device application analyzes the gestures being performed. By applying computer vision algorithms and gesture recognition techniques, the application can distinguish between the gestures made over Card A and Card B based on their unique characteristics. For instance, the user may swipe Card A from left to right, while simultaneously tapping Card B in a specific pattern. The camera captures these gestures, and the application recognizes the swipe gesture on Card A as an instruction to navigate through a menu, and the tapping pattern on Card B as a command to initiate a specific function. By associating distinct gestures with different cards, the user device application can provide a customized and context-aware experience for each card. This allows users to interact with multiple contactless cards simultaneously, each with its own set of gestures and actions, expanding the range of possibilities and enabling versatile interactions in various scenarios.

As a nonlimiting example, the user may often perform an authentication with their contactless card and their user device, e.g. their smart phone. The user can perform an authentication by tapping their card to their phone. Over a number of authentications, the user may develop a preferred card orientation in relation to the smart phone. For example, the user may always tap their card to the smart phone such that the face of the card with the contact pad is facing the user device. As another nonlimiting example, the user might prefer to tap their card such that the card is upside down.

In some embodiments, the user device application can adjust the predetermined time period dynamically. That is, the user device or user device application modifies the predefined time window within which certain actions are allowed or triggered based on changing conditions or user preferences. This feature allows for flexibility in responding to different situations, user behaviors, or environmental factors. The process of dynamically adjusting the predetermined time period involves monitoring various parameters and initiating a change or adjustment of the time period in response to such parameters. For example, the application continuously gathers relevant data, such as the frequency of contactless card interactions, the time taken for users to complete certain actions, the user's historical usage patterns, and even external factors like the time of day or the user's location. The application processes this data to identify patterns and trends. For instance, it might observe that during certain times of the day, users tend to complete actions faster, or that some users consistently require more time due to specific needs. the system might also allow users to manually adjust the predetermined time period through settings or preferences. This user input could be factored into the dynamic adjustment process. Based on the collected data and user preferences, the application could use algorithms to calculate an appropriate time period for executing actions. This might involve adjusting the time period based on historical averages, peak usage times, or individual user behavior. The application then dynamically adapts the time period. If the system detects that users are consistently taking longer to complete actions during a particular time of day, it might automatically extend the time window during those hours. For example, a user may frequently tap their card to their user device during rush hour to pay for public transportation. The application tracks the user's interactions, noting that during rush hours, there are often instances where the user takes a bit longer to complete the action. The system identifies a pattern of extended interaction times during these peak hours. The user sets a preference indicating that they would like a slightly longer time period during these peak hours. The application uses a weighted algorithm that combines the historical interaction data and the user preference to dynamically adjust the time window. During rush hours, the predetermined time period is extended by a few seconds. The next time the user taps their contactless card during a rush hour, the system uses the adjusted time period. The action is now allowed within the extended time frame, accommodating the user's unique needs without compromising security.

Although the figures primarily depict a system with a first communication field and a second communication field, it is important to note that the concept of multiple interactions can be accommodated within a single communication field. In such cases, the user device can maintain an active communication field that allows for successive interactions with one or more contactless cards without the need to close and reopen the field for each interaction.

Several references are made to counter values and time datums. In the context of the user device and user device application, a counter value is a numeric value that represents the progression of time or the number of occurrences of a particular event. It serves as a reference point for tracking and measuring the duration or frequency of actions or events within the system. The counter value can be implemented as a variable or data structure within the user device application. The application can utilize system clocks, timers, or other timing mechanisms available in the user device's operating system or hardware to increment the counter value at regular intervals or when specific events occur. With reference to the embodiments described herein, the counter value can be updated or incremented based on predefined criteria or triggers, such as the opening of a communication field, the detection of a contactless card, or the occurrence of a user interaction. The user device application may use programming logic and event handlers to keep track of these events and update the counter value accordingly. It can vary from millisecond-level updates for real-time applications to longer intervals for less time-critical processes. The update frequency is determined based on factors such as the desired accuracy of timing measurements, system performance considerations, and the nature of the interactions or events being tracked. By utilizing a counter value, the user device and user device application can precisely measure time durations, intervals between events, or other temporal aspects relevant to the interaction with contactless cards. This enables the implementation of time-based authentication, gesture recognition, or other functionalities that rely on precise timing or event sequencing.

In the context of this application, the time datums, such as the first time datum and second time datum, are closely associated with the counter values maintained by the user device application. These time datums are derived from the counter values and provide a specific point in time or a time-related value that helps determine the elapsed time between different events or interactions. The user device application utilizes the counter values, which represent the progression of time or event occurrences, to establish a temporal reference for generating the time datums. For example, the first time datum is obtained by capturing the counter value at the moment the contactless card enters the first communication field or the first interaction takes place. Similarly, the second time datum is generated by recording the counter value when the contactless card enters the second communication field or the second interaction occurs. By using the counter values as the basis for the time datums, the user device application can accurately measure the time difference between two events or interactions. This allows for precise timing calculations and comparisons to be performed, facilitating various functionalities and actions based on predefined time periods or thresholds. The association of time datums with counter values ensures that the timing measurements are consistent and reliable within the user device application. It enables the application to track and evaluate the elapsed time between different stages of the interaction process, such as the duration between taps or the time lapse between communication fields.

In the context of this application, the terms “card” and “contactless card” are not limited to a particular type of card. Rather, it is understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

In the context of this application, the term “tap” is used to describe an interaction between a contactless card and the user device, but it should not be limited to a literal physical tap. While a tap can certainly be one form of interaction, the concept of a tap is broader and encompasses various gestures and movements that initiate communication and trigger actions between the contactless card and the user device. A “tap” can refer to any intentional gesture or action performed by the user with the contactless card in close proximity to the user device. This can include actions such as swiping, sliding, hovering, or any other motion that establishes a connection between the card and the user device. The tap is essentially a trigger that initiates the communication between the card and the device, allowing data exchange and interaction to occur. The purpose of using the term “tap” in a broader sense is to encompass a range of possible gestures and movements that users can employ to interact with the contactless card. This flexibility allows for different modes of engagement and accommodates various user preferences and capabilities. Whether it is a physical tap, a swipe across a sensor, or any other gesture that enables communication, the term “tap” encompasses all these possibilities.

In some aspects, the techniques described herein relate to a system, including: a contactless card including a card memory; and a user device application including instructions for execution on a user device including a memory and a processor, wherein the user device application is configured to: after a first entry of the contactless card into a communication field, read the card memory, clear the card memory, transmit, over the communication field, a first time datum to the contactless card, wherein the card memory stores the first time datum, after a second entry of the contactless card into the communication field, read the first datum from the contactless card, compare the first time datum with a current counter value, clear the card memory of the contactless card, transmit a second time datum to the contactless card, wherein the card memory stores the second time datum, determine if the amount of time that has passed between the first time datum and the second time datum is within a predetermined time period, and perform, upon determining that the time that has passed between the first time datum and the second time datum is within the predetermined time period, an action.

In some aspects, the techniques described herein relate to a system, wherein the user device application, upon determining that the time that has passed between the first time datum and the second time datum is within the predetermined time period, is further configured to provide a visual feedback on a display of the user device regarding a status of the communication with the contactless card.

In some aspects, the techniques described herein relate to a system, wherein the user device application, upon determining that the time that has passed between the first time datum and the second time datum is within the predetermined time period, is further configured to provide a haptic feedback on the user device regarding a status of the communication with the contactless card.

In some aspects, the techniques described herein relate to a system, wherein the user device application is configured to determine a number of interactions between the contactless card and the user device within the predetermined time period.

In some aspects, the techniques described herein relate to a system, wherein the user device application is further configured to measure a duration of a presence of the contactless card in the communication field.

In some aspects, the techniques described herein relate to a system, wherein the predetermined time period is adjustable by a user via the user device.

In some aspects, the techniques described herein relate to a system, wherein the contactless card further includes a display element.

In some aspects, the techniques described herein relate to a system, wherein the contactless card is configured to activate the display element upon entering the communication field.

In some aspects, the techniques described herein relate to a system, wherein the display element is activated when the action is performed.

In some aspects, the techniques described herein relate to a method, including: opening, by a user device application including instructions for execution on a user device, a communication field; after a first entry of a contactless card into the communication field, reading, by the user device application, a card memory associated with the contactless card; clearing, by the user device application, the card memory; transmitting, by the user device application over the communication field, a first time datum to the contactless card, wherein the card memory stores the first time datum; after a second entry of the contactless card into the communication field, reading, by the user device application, the first datum from the card memory; comparing, by the user device application, the first time datum with a current counter value; clearing, by the user device application, the card memory; transmitting, by the user device application, a second time datum to the contactless card, wherein the card memory stores the second time datum; determining, by the user device application, if an amount of time that has passed between the first time datum and the second time datum is within a predetermined time period; and performing, by the user device application upon determining that the time that has passed between the first time datum and the second time datum is within the predetermined time period, an action.

In some aspects, the techniques described herein relate to a method, wherein the method further includes: after a third entry of the contactless card into the communication field, reading, by the user device application, the second datum from the card memory; comparing, by the user device application, the second time datum with an updated current counter value; clearing, by the user device application, the card memory; transmitting, by the user device application, a third time datum to the contactless card, wherein the card memory stores the third time datum; determining, by the user device application, if the amount of time that has passed between the second time datum and the third time datum is within the predetermined time period; and performing, by the user device application upon determining that the time that has passed between the second time datum and the third time datum is within the predetermined time period, the action.

In some aspects, the techniques described herein relate to a method, wherein the method further includes determining, by the user device application, a speed of the contactless card based on the time between the first time datum and the second time datum.

In some aspects, the techniques described herein relate to a method, wherein the method further includes adjusting, by the user device application, the predetermined time period dynamically based at least on one or more user historical data.

In some aspects, the techniques described herein relate to a method, wherein the first time datum and the second time datum are each counter values.

In some aspects, the techniques described herein relate to a method, wherein the method further includes storing, by the user device application, the first time datum and the second time datum in a database.

In some aspects, the techniques described herein relate to a method, wherein the method further includes: storing, by the user device application, the second time datum in a database; after a third entry of the contactless card into the communication field, reading, by the user device application, a second contactless card datum from the card memory; comparing, by the user device application, the third time datum with the second time datum; determining, by the user device application, if the amount of time that has passed between the second time datum and the third time datum is within the predetermined time period; and performing, by the user device application upon determining that the time that has passed between the second time datum and the third time datum is within the predetermined time period, the action.

In some aspects, the techniques described herein relate to a method, wherein the method further includes displaying, upon determining that the time that has passed between the first time datum and the second time datum is within the predetermined time period, a visual feedback on a display of the user device.

In some aspects, the techniques described herein relate to a method, wherein the method further includes providing, upon determining that the time that has passed between the first time datum and the second time datum is within the predetermined time period, a haptic feedback on the user device.

In some aspects, the techniques described herein relate to a method, wherein the method further includes detecting one or more motions made by the contactless card within the communication field.

In some aspects, the techniques described herein relate to a non-transitory computer readable medium containing computer executable instructions that, when executed by a device including a processor, configure the device to perform procedures including: opening a communication field; after a first entry of a contactless card into the communication field, reading a card memory associated with the contactless card; clearing the card memory; transmitting, over the communication field, a first time datum to the contactless card, wherein the card memory stores the first time datum; after a second entry of the contactless card into the communication field, reading the first datum from the card memory; comparing the first time datum with a current counter value; clearing the card memory; transmitting a second time datum to the contactless card, wherein the card memory stores the second time datum; determining if an amount of time that has passed between the first time datum and the second time datum is within a predetermined time period; and performing, upon determining that the time that has passed between the first time datum and the second time datum is within the predetermined time period, an action.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system, comprising:
a contactless card comprising a card memory; and
a user device application comprising instructions for execution on a user device comprising a memory and a processor, wherein the user device application is configured to:
after a first entry of the contactless card into a communication field, read the card memory,
clear the card memory,
transmit, over the communication field, a first time datum to the contactless card, wherein the card memory stores the first time datum,
after a second entry of the contactless card into the communication field, read the first datum from the contactless card,
compare the first time datum with a current counter value,
clear the card memory of the contactless card,
transmit a second time datum to the contactless card, wherein the card memory stores the second time datum,
determine if the amount of time that has passed between the first time datum and the second time datum is within a predetermined time period, and
perform, upon determining that the time that has passed between the first time datum and the second time datum is within the predetermined time period, an action.

2. The system of claim 1, wherein the user device application, upon determining that the time that has passed between the first time datum and the second time datum is within the predetermined time period, is further configured to provide a visual feedback on a display of the user device regarding a status of the communication with the contactless card.

3. The system of claim 1, wherein the user device application, upon determining that the time that has passed between the first time datum and the second time datum is within the predetermined time period, is further configured to provide a haptic feedback on the user device regarding a status of the communication with the contactless card.

4. The system of claim 1, wherein the user device application is configured to determine a number of interactions between the contactless card and the user device within the predetermined time period.

5. The system of claim 1, wherein the user device application is further configured to measure a duration of a presence of the contactless card in the communication field.

6. The system of claim 1, wherein the predetermined time period is adjustable by a user via the user device.

7. The system of claim 1, wherein the contactless card further comprises a display element.

8. The system of claim 7, wherein the contactless card is configured to activate the display element upon entering the communication field.

9. The system of claim 8, wherein the display element is activated when the action is performed.

10. A method, comprising:
opening, by a user device application comprising instructions for execution on a user device, a communication field;
after a first entry of a contactless card into the communication field, reading, by the user device application, a card memory associated with the contactless card;
clearing, by the user device application, the card memory;
transmitting, by the user device application over the communication field, a first time datum to the contactless card, wherein the card memory stores the first time datum;
after a second entry of the contactless card into the communication field, reading, by the user device application, the first datum from the card memory;
comparing, by the user device application, the first time datum with a current counter value;
clearing, by the user device application, the card memory;
transmitting, by the user device application, a second time datum to the contactless card, wherein the card memory stores the second time datum;
determining, by the user device application, if an amount of time that has passed between the first time datum and the second time datum is within a predetermined time period; and
performing, by the user device application upon determining that the time that has passed between the first time datum and the second time datum is within the predetermined time period, an action.

11. The method of claim 10, wherein the method further comprises:
after a third entry of the contactless card into the communication field, reading, by the user device application, the second datum from the card memory;
comparing, by the user device application, the second time datum with an updated current counter value;
clearing, by the user device application, the card memory;
transmitting, by the user device application, a third time datum to the contactless card, wherein the card memory stores the third time datum;
determining, by the user device application, if the amount of time that has passed between the second time datum and the third time datum is within the predetermined time period; and
performing, by the user device application upon determining that the time that has passed between the second time datum and the third time datum is within the predetermined time period, the action.

12. The method of claim 10, wherein the method further comprises determining, by the user device application, a speed of the contactless card based on the time between the first time datum and the second time datum.

13. The method of claim 10, wherein the method further comprises adjusting, by the user device application, the predetermined time period dynamically based at least on one or more user historical data.

14. The method of claim 10, wherein the first time datum and the second time datum are each counter values.

15. The method of claim 10, wherein the method further comprises storing, by the user device application, the first time datum and the second time datum in a database.

16. The method of claim 10, wherein the method further comprises:
storing, by the user device application, the second time datum in a database;
after a third entry of the contactless card into the communication field, reading, by the user device application, a second contactless card datum from the card memory;
comparing, by the user device application, the third time datum with the second time datum;
determining, by the user device application, if the amount of time that has passed between the second time datum and the third time datum is within the predetermined time period; and
performing, by the user device application upon determining that the time that has passed between the second time datum and the third time datum is within the predetermined time period, the action.

17. The method of claim 10, wherein the method further comprises displaying, upon determining that the time that has passed between the first time datum and the second time datum is within the predetermined time period, a visual feedback on a display of the user device.

18. The method of claim 10, wherein the method further comprises providing, upon determining that the time that has passed between the first time datum and the second time datum is within the predetermined time period, a haptic feedback on the user device.

19. The method of claim 10, wherein the method further comprises detecting one or more motions made by the contactless card within the communication field.

20. A non-transitory computer readable medium containing computer executable instructions that, when executed by a device comprising a processor, configure the device to perform procedures comprising:
opening a communication field;
after a first entry of a contactless card into the communication field, reading a card memory associated with the contactless card;
clearing the card memory;
transmitting, over the communication field, a first time datum to the contactless card, wherein the card memory stores the first time datum;
after a second entry of the contactless card into the communication field, reading the first datum from the card memory;
comparing the first time datum with a current counter value;
clearing the card memory;
transmitting a second time datum to the contactless card, wherein the card memory stores the second time datum;
determining if an amount of time that has passed between the first time datum and the second time datum is within a predetermined time period; and
performing, upon determining that the time that has passed between the first time datum and the second time datum is within the predetermined time period, an action.
